(19) United States
(12) Patent Application Publication
(10) Pub. No.: US 2014/0214429 A1
(43) Pub. Date: Jul. 31, 2014

(54) Method for Voice Activation of a Software Agent from Standby Mode

(71) Applicant: Lothar Pantel, Neckargemuend (DE)

(72) Inventor: Lothar Pantel, Neckargemuend (DE)

(21) Appl. No.: 14/152,780

(22) Filed: Jan. 10, 2014

(30) Foreign Application Priority Data
Jan. 25, 2013 (DE) 102013001219.8

(51) Int. Cl. G10L 21/16

(52) U.S. Cl. CPC G10L 21/16
USPC 704/275

(57) ABSTRACT

A method for voice activation of a software agent from a standby mode. In one embodiment, an audio recording (2) is buffered in an audio buffer (6) and at the same time, the audio recording is input to a secondary voice recognition process (7) which is economical in terms of energy and has an increased false positive rate. When a keyword is recognized, a primary voice recognition process (8) is activated from an inactive state, which converts the audio buffer to text and inputs it to a dialog system (9) which analyzes as to whether there is a relevant question made by the user. If this is the case, the user gets an acoustic reply (3), and if this is not the case, the dialog system and the primary voice recognition process immediately return to the inactive state and transfer the control to the secondary voice recognition process.

### CROSS-REFERENCE TO RELATED APPLICATION

This application claims priority from German Patent Application No. DE 10 2013 001 219.8, filed Jan. 25, 2013, the entire disclosure of which is herein expressly incorporated by reference.

### BACKGROUND OF THE INVENTION

Voice recognition, that is, the conversion of acoustic speech signals to text, concretely, the conversion to a digital text representation by means of character encoding, is known. It is possible to control systems without haptic operation. The methods and systems of U.S. Pat. No. 8,260,618 and U.S. Pat. No. 7,953,599 describe how devices can be controlled or also activated by voice.

Owing to their small size, the ergonomics of smartphones, i.e. mobile telephones with computer functionality, is very restricted when they are operated by touch-screen. An alternative is personal assistant systems where the smartphone can be controlled with voice commands, in part also with natural speech without special control commands. A known example is the “Siri” system in the “iPhone” from Apple (source: http://www.apple.com). A personal assistant system can be an independent application (“app”) on the smartphone or be integrated in the operating system. Voice recognition, interpretation and reaction can be done locally on the hardware of the smartphone. But because of the greater processing power an Internet-based server network (“in the cloud”) is normally used, with which the personal assistant system communicates, i.e. compressed voice or sound recordings are sent to the server or server network and the verbal reply generated by voice synthesis is streamed back to the smartphone.

Personal assistant systems are a subset of software agents. There are various options for interaction: e.g. retrieval of facts or knowledge, status updates in social networks or dictation of emails. In most cases, a dialog system (or a so-called chatbot) is used for the personal assistant system which operates partly with semantic analysis or approaches from artificial intelligence to simulate a virtually realistic conversation about a topic.

Another example of a personal assistant is the system designated as “S voice” on the “Galaxy S III” smartphone from Samsung (source: http://www.samsung.com). This product has the option of waking up the smartphone from a standby or sleep state, namely by means of a voice command, without touching the touch-screen or any key. For this purpose the user can store a spoken phrase in the system settings which is used for waking up. “Hi Galaxy” has been factory set. The user must explicitly activate the acoustic monitoring and again deactivate it later because the power consumption would be too great for a day-long operation. According to the manufacturer, the system is provided for situations in which manual operation is not an option, e.g. while driving. By way of example, the driver gives the verbal command “Hi Galaxy”, to which, depending on the setting, the “S voice” replies with the greeting: “What would you like to do?” Only now, in a second step, and after the user has already lost productive time due to his first command and waiting for the wake up time—including the greeting—he can actually ask e.g. “What is the weather like in Paris?”

By storing a limited number of further phrases in the control panel very simple actions can be activated by voice. By means of the command “take a picture” the camera app could be started. It is, however, not possible to ask the smartphone or rather the “S voice” complex questions or request complex actions from the smartphone, as long as the system is in the standby or sleep state. A question such as “Will I need a raincoat in Paris the day after tomorrow?”, cannot be answered by the system from the standby or sleep state in spite of the acoustic monitoring. It has to be explicitly awakened for this purpose.

The voice activation technology used in the “Galaxy S III” smartphone is from Sensory Inc. (source: http://www.sensoryinc.com). The manufacturer emphasizes the extremely low false positive rate on acoustic monitoring by means of their “TrulyHandsFree” technology. “False positive” means falsely interpreting other noise as a phrase and the undesired initiation of the trigger. The manufacturer restricts his descriptions to the serial process during which the device is first brought to life by means of a keyword, only then to be controlled via further commands. Quote: “TrulyHandsFree can be always-on and listening for dozens of keywords that will bring the device to life to be controlled via further voice commands.” No other procedure is disclosed.

### SUMMARY OF THE INVENTION

The object underlying the present invention is to provide a method which permits asking a software agent or a personal assistant system, which is in a standby or sleep state, complex questions, or also messages and requests, via “natural” voice, whereby the system should immediately reply or respond with a final and complete reply or action without further interposed interaction steps. The complexity of the supported questions, messages, and requests should in this case be comparable or identical to the complexity that the system handles during normal operation. Furthermore, by its concept the method should be especially advantageous for a day-long standby mode of the software agent. The difference between the standby mode and the regular operation should hardly be perceptible to the user, i.e. the user should have the impression that the system also listens with the same attention in the standby mode as during regular operation.

According to the present invention, the object mentioned above is attained by means of the features of independent claim 1. Advantageous embodiments, possible alternatives, and optional functionalities are specified in the dependent claims.

A software agent or a personal assistant system is in a power-saving standby mode or sleep state, the ambient noise—for example voice—picked up by one or more microphones being digitized and continually buffered in an audio buffer, so that the audio buffer constantly contains the ambient noises or voice from the most recent past, by way of example, those of the last 30 seconds. Apart from that, the digitized ambient noise or voice that is picked up by the microphone (or several microphones) is input without significant delay to an energy saving secondary voice recognition process, which, on recognition of a keyword or a phrase from a defined keyword- and phrase-catalog, starts a primary voice recognition process or activates it from an inactive or sleep state.

The more energy-intensive, primary voice recognition process now converts either the entire audio buffer or the most recent part starting at a recognized voice pause (which typically characterizes the beginning of a question phrase) into text, the primary voice recognition process then seamlessly continuing the conversion of the live transmission from the microphone. The text generated via voice recognition, from the audio buffer as well as from the subsequent live transmission, is input to a dialog system (or chatbot), which is likewise started or activated from a sleep state or inactive state.

The dialog system analyzes the content of the text as to whether it contains a question, a message, and/or a request made by the user to the software agent or to the personal assistant system, for example, by means of semantic analysis.

If a request or a topic is recognized in the text, which the software agent or personal assistant system is competent for, an appropriate action is initiated by the dialog system, or an appropriate reply is generated and communicated to the user via an output device (e.g. loudspeaker and/or display). The software agent or personal assistant is now in full regular operation and interacting with the user.

However, if the analyzed text (from the audio buffer and the subsequent live transmission) does not contain any relevant or evaluable content, by way of example, when the text string is empty or the dialog system cannot recognize any sense in the word arrangement, the dialog system and the primary voice recognition process is immediately returned to the sleep state or terminated in order to save power. The control then again returns to the secondary voice recognition process which monitors the surrounding noise or the voice for further keywords or phrases.

### BRIEF DESCRIPTION OF THE DRAWINGS

Further objectives, features, advantages, and possible applications of the method according to the present invention will be apparent from the description of the drawings below. In this connection, all described and/or depicted features, separately or in any combination, are the subject matter of the invention, independently from the synopsis in the individual claims.

FIG. 1 Smartphone with microphone and loudspeaker on which a personal assistant runs as software.

FIG. 2 Data flow diagram of the basic method.

FIG. 3 Schematic diagram of the time flow of the process on a time axis t. The keyword in the center of the text sample is “what”.

FIG. 4 A first embodiment in which the primary voice recognition process (executed on a processor) as well as the secondary voice recognition process (implemented as a hardware circuit) are located in the local terminal.

FIG. 5 A simple embodiment in which the primary voice recognition process as well as the secondary voice recognition process are executed on the same single core or multi-core processor.

FIG. 6 Embodiment in which the secondary voice recognition process (implemented as a hardware circuit) is located in the local terminal, and in which the primary voice recognition process is executed on the processor of a server which is connected via a network.

FIG. 7 Flowchart of the method including the recognition of the beginning of a sentence, the end of a sentence and irrelevant audio recordings.

### DETAILED DESCRIPTION OF THE INVENTION

A terminal can be a mobile computer system or a stationary, cable-based computer system. The terminal is connected to a server via a network and communicates according to the client-server model. Mobile terminals are connected to the network via radio. Typically, the network is the Internet.

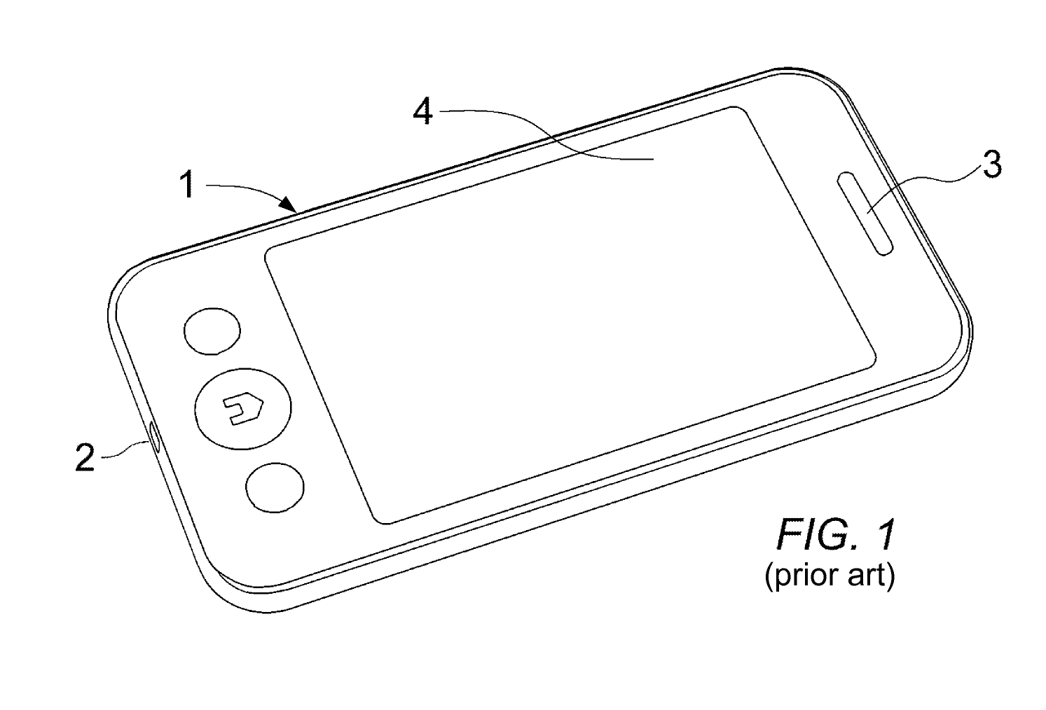

FIG. 1 depicts a smartphone which represents the terminal 1. The software of a personal assistant system runs on this terminal 1. The terminal 1 has a device for digital audio recording and reproduction, typically, one or more microphones 2 and one or more loudspeakers 3 together with the corresponding A/D-converter 5 and D/A-converter circuits. During regular full operation, the digital audio recording 11 (ambient noise or voice) is input to a primary voice recognition process 8. Depending on the embodiment, the primary voice recognition process 8 can be realized in software or as a hardware circuit. In addition, depending on the embodiment, the primary voice recognition process 8 can be located in the local terminal 1 or on a server 28, the digital audio recording then being continually transmitted via the network 29 to the server 28.

A typical embodiment uses the server 28 for the the primary voice recognition process 8, said primary voice recognition process 8 being implemented in software.

The primary voice recognition process 8 is a high-grade voice recognition technique, which converts the acoustic information to text 13 as completely as possible during the dialog with the user and typically uses the entire supported vocabulary of the voice recognition system. This operating state is designated as full operation. Prior or after the dialog with the user, the terminal 1 can switch to a sleep state or standby mode to save energy.

Apart from voice recognition for full operation, the system has a second voice recognition process for the sleep state or standby mode. This secondary voice recognition process 7 is optimized for a low consumption of resources and, depending on the embodiment, can likewise be implemented in software or as a hardware circuit. When designed as hardware, attention should be paid to low power consumption, and when implemented in software, attention should be paid to a low demand on resources, like the processor or RAM. Depending on the embodiment, the secondary voice recognition process 7 can be realized on the local terminal 1 or on the server 28, the digital audio recording 11 then being transmitted to the server 28. In a power-saving embodiment the voice recognition in standby mode is done on the local terminal 1, the secondary voice recognition process 7 being realized as a FPGA (field programmable gate array) or as an ASIC (application specific integrated circuit) and optimized for low power consumption.

In order for a low consumption of resources by the secondary voice recognition process 7 to be possible, it has a very limited vocabulary. The secondary voice recognition process 7 can thus only understand a few words or short segments from idiomatic expressions (phrases). These keywords 18 and phrases should be selected such that they contain the typical features when contacting or asking a question to the personal assistant system. The selected keywords 18 and phrases need not necessarily be at the beginning of a sentence. For example all keywords 18 and phrases to infer a question are suitable: e.g. “do you have”, “have you got”, “are there”, “do I need”, “do I have”.

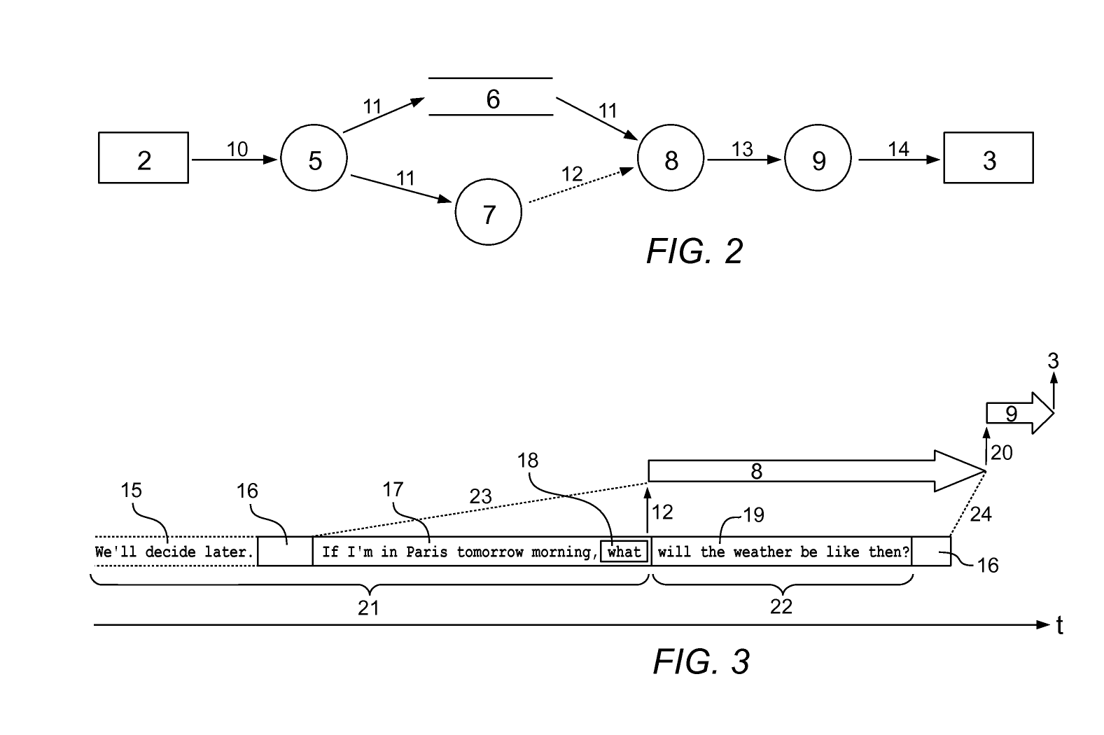

In the standby mode, all incoming audio signals 11 are buffered in an audio buffer 6 for a certain time. (See FIG. 2) In a simple case, the RAM is used for this purpose. If the secondary voice recognition process 7 is located in the terminal 1, the audio buffer 6 should also be located in the terminal 1. If the standby voice recognition is server-based, the audio buffer 6 should also be managed by the server 28.

The length of the audio buffer 6 should be selected such that several spoken sentences fit into it. Practical values range between 15 seconds and 2 minutes.

As soon as the secondary voice recognition process 7 recognizes a potentially relevant keyword 18 or a phrase, e.g. “do you know”, it arranges the temporary wakeup 12 of the primary voice recognition process 8 and a switch to full operation takes place. The content 21 of the audio buffer 6 is now handed over to the primary voice recognition process 8.

In a simple embodiment, the audio buffer 6 is located in the RAM of terminal 1. If the primary voice recognition process 8 is also located on the terminal 1, accessing the audio buffer 6 in the RAM will be sufficient. If the primary voice recognition process 8 is executed on the server 28, the content 21 of the audio buffer 6 is now transferred to the server 28 via the network 29.

The primary voice recognition process 8 now has the past of a potential conversation available via the audio buffer 6, by way of example, the last 30 seconds. The primary voice recognition process 8 must be able to process the audio data 11 with high priority: The objective is to promptly empty the audio buffer 6 in a timely way in order to again process live audio data 22 as soon as possible. (See FIG. 3 and the corresponding list with reference numerals.) The result of the primary voice recognition process 8 is the spoken text 13 from the recent past up to the present.

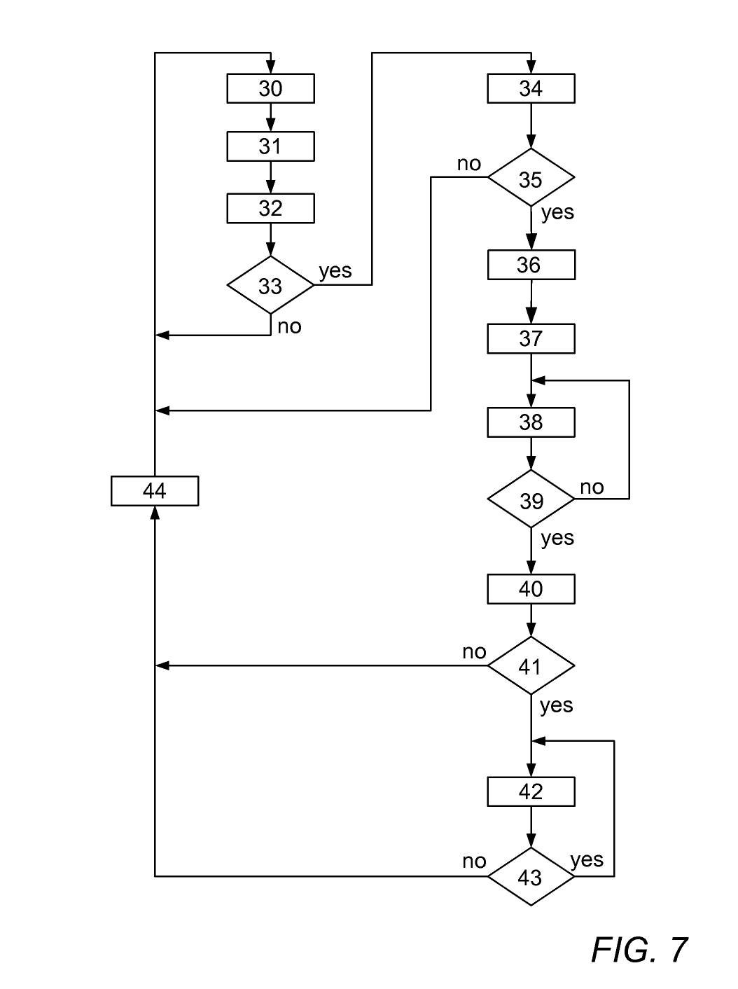

This text 13 is now input to the dialog system 9 which, by means of semantic analysis or also artificial intelligence, analyzes to what extent a query to the personal assistant system actually exists. It is also possible that the keyword 18 recognized by the secondary voice recognition process 7 does no longer appear in the current text 13 because the voice recognition during full operation (primary voice recognition process 8) is of a higher quality and the secondary voice recognition process 7 was therefore wrong. In all cases in which the audio recording 21 (located in the audio buffer 6) and the subsequent live audio data 22 turns out to be irrelevant, the dialog system 9 arranges an immediate return to the standby mode, in particular if there is only background noise or if the meaning of the text 13 is not recognized by the dialog system 9. (See the flowchart in FIG. 7 and the corresponding list with reference numerals.)

If the dialog system 9, however, concludes that the question, message, or request contained in the audio buffer 6 is relevant, the terminal 1 remains in full operation and the dialog system 9 will interact with the user. As soon as there are no more queries or messages from the user, the terminal 1 again switches to standby mode and thus transfers control to the secondary voice recognition process 7.

Additional embodiments are described in the following. Alternatives or optional functions are also mentioned in some cases:

In one embodiment, after recognizing a keyword 18 or a phrase by the secondary voice recognition process 7, first of all the audio buffer 6 is scanned for the beginning of the sentence with the question, message, or request. In most cases, it can be assumed that there is a short fraction of time without voice (that is to say with relative silence with respect to the ambient noise) before the beginning of a sentence because most people make a short pause 16 when they want to give the personal assistant a concrete, well formulated question, message or request. (See FIG. 3)

In order to find the beginning of a sentence the audio buffer 6 is scanned backward in time starting at the position in time of the recognized keyword 18 or phrase until a period is found that can be interpreted as a silence 16. Typically, the duration of the period with the speech pause 16 should be at least one second. As soon as a position with a relative silence 16 is found and thus the probable beginning of a sentence is established, the subsequent content 17 of the audio buffer 17 is then handed over to the primary voice recognition process 8, which is started or activated next to generate the text 13.

If during the evaluation of the text 13 the dialog system 9 does not recognize any meaning in the text 13, possibly because the beginning of the sentence was incorrectly interpreted, there can be a second, optional step: The entire content 21 of the audio buffer 6 can be converted to text 13 together with the subsequent live transmission 22 and be analyzed by the dialog system 9.

If it is not possible to localize a position of relative silence 16 in the entire audio buffer 6 then probably there is no question, message, or request to the personal assistant system, but interfering noise or a conversation between people. In this case, there is no need to start or activate the primary voice recognition process 8. (See FIG. 7)

In order for a user not to have to wait excessively long for a reply or action, it is advantageous that after activation 12 via a keyword 18 or via phrase, the primary voice recognition process 8 is executed with high priority and completed in a short time. (See the dotted lines 23 and 24 in FIG. 3.)

Since according to the present invention, a full-fledged voice recognition is realized by the primary voice recognition process 8, the secondary voice recognition process 7 can have an increased false positive rate when recognizing keywords 18 or phrases. That is to say the trigger 12 of the secondary voice recognition process 7 reacts very sensitive: During monitoring the ambient noise, overlooking a keyword 18 or phrase is extremely rare. If other noises or other words are falsely interpreted as keywords 18 or phrases, these errors are then corrected by the primary voice recognition process 8. As soon as the faulty trigger 12 is recognized, the primary voice recognition process 8 is immediately terminated or deactivated again.

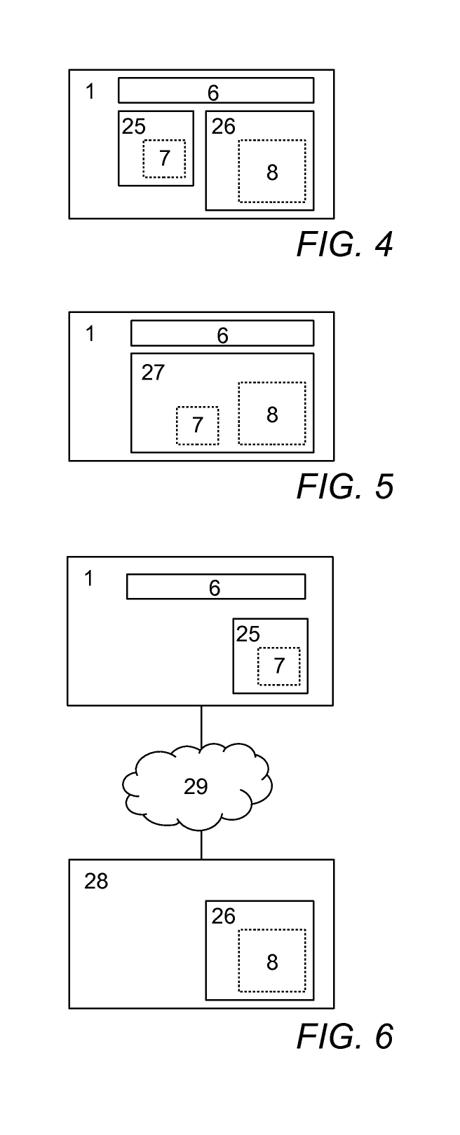

According to the present invention, the highly reduced recognition performance of the secondary voice recognition process 7 makes it possible to design it as especially energy saving; by way of example, as software running on a slow clocked processor with low power consumption, or on a digital signal processor that is likewise optimized for low power consumption. An FPGA or an ASIC, or, in general, an energy saving hardware circuit 25 is suitable, too. (See FIG. 4)

In case the primary voice recognition process 8 as well as the secondary voice recognition process 7 is running on the local hardware 1, they can both run on the same single core or multi-core processor 27, the secondary voice recognition process 7 running in an especially resource conserving mode of operation with low memory requirements and low power consumption. (See FIG. 5)

Alternatively the primary voice recognition process 8 and the dialog system 9 run on an external server 28 or on a server network. In this connection, the entire content 21 or the most recent content 17 of the audio buffer 6, and subsequently also the live transmission 22 is transferred to the server 28 or server network via a network 29 or radio network. Typically, the network 29 is the Internet. (See FIG. 6)

After a voice activation 12 triggered by the secondary voice recognition process 7 a latency or transmission delay will occur as soon as the content 17 of the audio buffer 6 has to be transferred via the network 29 to the server 28 or server network, so that the primary voice recognition process 8 and the dialog system 9 can evaluate the content. In order to prevent this, an “anticipatory standby mode” can be used: As soon as the presence of a user is detected, the “anticipatory standby mode” transfers the content 21 of the audio buffer 6 and the ensuing live transmission 22 of the ambient noise or voice to the external server 28 or server network. The audio data 11 are temporarily stored there, so that in the event of a voice activation 12, the primary voice recognition process 8 can access the audio data 11 almost without latency.

Furthermore, in the “anticipatory standby mode”, the secondary voice recognition process 7 can optionally intensify the monitoring of the ambient noise for keywords 18 or phrases.

The presence of a user can be assumed when there are user activities; by way of example, input via a touchscreen 4 or movements and changes in the orientation of the terminal 1 which are detected by means of acceleration- and position-sensors. It is likewise possible to recognize changes in brightness by means of a light sensor, to recognize changes in position which can be determined via satellite navigation (e.g. GPS), and face recognition via camera.

Basically, the entries in the keyword- and phrase-catalog can be divided into:
Question words and question phrases: e.g. “who has”, “what”, “how is”, “where is”, “are there”, “is there”, “are there”, “do you know”, “can one”.
Requests and commands: By way of example: “Please write an email to Bob”. The phrase “write an email” will be recognized. Another example: “I would like to take a picture”. The phrase “take a picture” will be recognized.
Nouns referring to topics on which there is information in the database of the dialog system: e.g. “weather”, “appointment”, “deadline”, “football”, “soccer”.
Product names, nicknames and generic terms for a direct address of the personal assistant system. Examples of generic terms: “mobile”, “mobile phone”, “smartphone”, “computer”, “navigator”, “navi”.

Using a product name as a keyword has the advantage that compared to a catalog with question words, the frequency at which the system unnecessarily changes to full operation can be reduced. When using a product name, it can be assumed that the personal assistant system is in charge. Example: “Hello, <product name>, please calculate the square root of 49”, or “What time is it, <product name>?”

In an advantageous embodiment, the keyword- and phrase-catalog can be modified by the user. If the voice activation is done via the product name or a generic term, the user could, for example, define a nickname for the terminal 1 as a further, alternative keyword.

The user could also delete some keywords or phrases from the catalog, e.g. if the personal assistant system should report less frequently or only in relation to certain topics.

As soon as the secondary voice recognition process 7 has recognized a keyword 18 or a phrase, the user has to wait for a few moments until the primary voice recognition process 8 and the dialog system 9 have generated a reply or response. In a further embodiment, on recognition of a keyword 18 or phrase by the secondary voice recognition process 7, an optical, acoustic and/or haptic signal is output to the user, for example, a short beep through the loudspeaker 3 or a vibration of the terminal 1, an indication on the display 4 or by turning on the backlight of the display 4. The user is then informed that his/her query has reached the terminal 1. At the same time, this signaling is only minimally disturbing in case the keyword 18 or the phrase was erroneously recognized. In this case, if no relevant or evaluable content can be recognized in the audio buffer 6 or from the resulting text 13, it is advantageous to output a further optical, acoustic or haptic signal which is conveniently different from the first signal, by way of example, a double beep (first high, then low) or by turning off the backlight of the display 4 that had previously been turned on.

In another embodiment, the personal assistant system can distinguish different voices or speakers, so that only questions, messages, and requests coming from an entitled person are replied by the dialog system 9, by way of example, only questions by the user. As the primary voice recognition process 8 has a considerably greater recognition performance, according to the present invention, only this process can distinguish different speakers by their voice. The secondary voice recognition process 7 cannot distinguish different speakers.

Given a keyword 18 or phrase spoken by a still unidentified speaker, the secondary voice recognition process 7 will arrange the execution of the primary voice recognition process 8. The primary voice recognition process 8 recognizes from the speaker's voice whether he/she is entitled to use the personal assistant system. If a corresponding entitlement is not available, the primary voice recognition process 8 terminates itself or returns to the inactive state, and the control is again passed to the secondary voice recognition process 7. During this procedure, the dialog system 9 can remain in the inactive or sleep state.

In an optional embodiment, the dialog system 9 takes the context of a conversation into consideration: A conversation between people is monitored and a keyword 18 or a phrase from the keyword- and phrase-catalog appears in the conversation (e.g. “soccer”), so that the primary voice recognition process 8 and the dialog system 9 is started or activated. The dialog system 9 checks if it is competent for the content 21, 22 of the current conversation, in particular, whether a question, message, or request was made to the personal assistant system. If the dialog system 9 is not in charge, the dialog system 9 stores the context and/or topic and/or keywords or phrases for later reference and returns to the sleep state together with the primary voice recognition process 8. If the dialog system 9 is again started or activated by another keyword 18 or phrase (e.g. “who”) at a later time, the previously stored information can be considered as a context. In accordance with the above example, the question “Who won the match today?” can be replied with the soccer results of the current match day.

Because the complete sentence of the user's question, message, or request is available in the audio buffer 6, it is also possible to repeatedly perform a voice recognition within the primary voice recognition process 8. In the first instance, the voice recognition could be done with an especially quick algorithm which reduces the user's waiting time.

In case the resulting text 13 is not valid for the dialog system 9 or cannot be evaluated, the audio buffer 6 can again be converted to text 13, namely by means of one or more voice recognition methods, which e.g. are particularly resistant to background noise.

Although the description above contains many specificities, these should not be construed as limiting the scope of the embodiments but as merely providing illustrations of some of several embodiments. Thus the scope of the embodiments should be determined by the appended claims and their legal equivalents, rather than by the examples given.

### LIST OF REFERENCE NUMERALS

1 Smartphone (Terminal)

2 Microphone

3 Loudspeaker

4 Display/Touchscreen

5 Analog-Digital Converter (ND)

6 Audio Buffer

7 Secondary Voice Recognition Process

8 Primary Voice Recognition Process

9 Dialog System

10 Analog Microphone Signals

11 Digital Audio Signals

12 Activation Signal (Trigger) After Recognizing A Keyword

13 Text (Digital Representation by Means of Character Coding)

14 Reply or Response of the Dialog System

15 Audio Recording of the Previously Spoken Sentence in the Audio Buffer

16 Audio Recording of the Speech Pause (Silence)

17 Audio Recording of the Current Sentence (First Part) in the Audio Buffer

18 Recognized Keyword or Phrase

19 Live Transmission of the Current Sentence (Second Part)

20 Start of the Dialog System

21 Audio Data of the Most Recent Past in the Audio Buffer

22 Live Transmission of the Audio Data

23 Processing Delay Relative to the Beginning of the Sentence

24 Reduced Processing Delay at the End of the Sentence

25 Hardware Circuit (Digital Signal Processor, FPGA or ASIC)

26 Main Processor

27 Single Core or Multi-Core Processor with Power Saving Function

28 Server or Server Network

29 Network (Radio, Internet)

30 Digitize Microphone Signals via A/D Converter

31 Buffer Live Audio Data in the Audio Buffer

32 Execute Secondary Voice Recognition Process with Live Audio Data

33 Keyword or Phrase Found?

34 Scan Audio Buffer Backward for a Speech Pause

35 Was the Speech Pause Found?

36 Start/Activate Primary Voice Recognition Process and Dialog System

37 Apply Primary Voice Recognition Process to Audio Buffer Starting at Speech Pause

38 Apply Primary Voice Recognition Process to New Live Audio Data

39 Speech Pause at the End of Sentence Found?

40 Analyze the Text of the Sentence in the Dialog System

41 Does the Text Contain A Relevant Question, Message, or Command?

42 Generate Reply or Activate Action/Response (Full Regular Operation)

43 Are there Further Questions/Commands by the User? (Full Regular Operation)

44 Terminate/Deactivate Primary Voice Recognition Process and Dialog System

What is claimed is:

1. A method for voice activation of a software agent, in particular of a personal assistant system from a standby mode, comprising:
providing a microphone (2), an output device (3, 4), an audio buffer (6), and a hardware infrastructure which is able to execute a primary voice recognition process (8), a secondary voice recognition process (7) and a dialog system (9),
continually buffering an audio recording (11) picked up by said microphone (2) in said audio buffer (6), so that said audio buffer (6) always contains the audio recording (11) of the most recent past, and
inputting said audio recording (11) picked up by said microphone (2) to said secondary voice recognition process (7), which, on recognizing a keyword (18) or a phrase from a previously defined keyword- and phrase-catalog starts or activates (12) from an inactive state said primary voice recognition process (8) which converts the entire or most recent content (21, 17) of said audio buffer (6) as well as the subsequent live transmission (22) to text (13) and inputs this text (13) to said dialog system (9) which likewise starts or is activated (20) from an inactive state and analyzes the content of said text (13) as to whether it contains a question, a message or a request made by the user to said software agent, in which case, if it is answered in the affirmative, said dialog system (9) triggers an appropriate action or generates an appropriate reply (14) and contacts the user via said output device (3, 4) and otherwise, if said text (13) does not contain any relevant or any evaluable content, said dialog system (9) and at the latest then also said primary voice recognition process (8) return to the inactive state or terminate and again return the control to said secondary voice recognition process (7),
whereby the interplay between said secondary voice recognition process (7) and said primary voice recognition process (8) helps to maximize the idle time of said primary voice recognition process (8) while the user still can ask said software agent complex questions in standby mode and he gets instant and final replies or actions without further interposed interaction steps such that the user has the impression that said software agent listens with the same attention in the standby mode as during regular operation.

2. The method of claim 1, further comprising scanning said audio buffer (6) backwards, beginning at the position in time of the recognized keyword (18) or phrase until a period is found which can be interpreted as a speech pause (16), the most recent content (17) of said audio buffer (6), beginning at the position with the recognized speech pause (16), being handed over to said primary voice recognition process (8).

3. The method of claim 2 wherein said primary voice recognition process (8) remains in the inactive state, if no speech pause (16) is found in said audio buffer (6) in a range beginning at said position in time of the recognized keyword (18) or phrase up to the oldest entries.

4. The method of claim 1 wherein after activation (12) via a keyword (18) or phrase, said primary voice recognition process (8) is executed with high priority and completed after a short time (23, 24), whereby said audio buffer (6) is promptly empty in order to again process live audio data (22) as soon as possible, which minimizes the time the user has to wait for the reply (14) or action.

5. The method of claim 1 wherein said secondary voice recognition process (7) has an increased false positive rate on recognition of keywords (18) and/or phrases, whereby said secondary voice recognition process (7) can be implemented in an especially energy-saving design, correcting every false positive error of said secondary voice recognition process (7) by said primary voice recognition process (8).

6. The method of claim 1 wherein said secondary voice recognition process (7)
a) runs as a software on a processor operating with low power consumption, or
b) is executed on a digital signal processor, which is optimized for low power consumption, or
c) is implemented as a FPGA or ASIC, which is optimized for low power consumption, or
d) is implemented as a hardware circuit (25), which is optimized for low power consumption.

7. The method of claim 1 wherein said primary voice recognition process (8) and said secondary voice recognition process (7) run on the same single core or multi-core processor (27), the secondary voice recognition process (7) running in a resource-saving mode of operation, in particular, with low power consumption.

8. The method of claim 1 wherein said primary voice recognition process (8) and said dialog system (9) run on an external server (28) or on a server network, the entire or the most recent content (21, 17) of said audio buffer (6) being transferred via a network (29) and/or radio network to said server (28) or server network.

9. The method of claim 8, further comprising switching said software agent to an anticipatory standby mode as soon as the presence of the user is detected by means of a sensor, while the entire or the most recent content (21, 17) of said audio buffer (6) and/or the live transmission (22) of said audio recording (11) is continually transferred via said network (29) to said external server (28) or server network and buffered there,
whereby, in case of voice activation (12) said primary voice recognition process (8) can access the buffered audio recording (11) almost latency-free.

10. The method of claim 9 wherein said sensor is a user interface for user input and/or an acceleration- and/or position-sensor measuring movement or changes in position and/or a light sensors measuring changes in the brightness and/or a satellite navigation sensor measuring changes in position and/or a camera for face recognition,
whereby by means of said sensor the user's activity is monitored and hence the user's presence is detected.

11. The method of claim 1, further comprising intensifying the monitoring of said audio recording (11) for keywords (18) and/or phrases by said secondary voice recognition process (7) as soon as the presence of the user is detected by means of a sensor, whereby said software agent switches to an anticipatory standby mode and is prepared for user input.

12. The method of claim 11 wherein said sensor is a user interface for user input and/or an acceleration- and/or position-sensor measuring movement or changes in position and/or a light sensors measuring changes in the brightness and/or a satellite navigation sensor measuring changes in position and/or a camera for face recognition,
whereby by means of said sensor the user's activity is monitored and hence the user's presence is detected.

13. The method of claim 1 wherein said keyword- and phrase-catalog can be modified, expanded and/or reduced by the user by means of a user interface (4).

14. The method of claim 1 wherein said keyword- and phrase-catalog contains question words, questioning phrases, requests and/or commands.

15. The method of claim 1 wherein said keyword- and phrase-catalog contains nouns relating to topics on which information is available in the database of said dialog system.

16. The method of claim 1 wherein said keyword- and phrase-catalog contains product names, nicknames and/or generic terms.

17. The method of claim 1, further comprising outputting an optical, acoustic and/or haptic signal to the user by means of an output device (3, 4) as soon as a keyword (18) or a phrase is recognized by said secondary voice recognition process (7).

18. The method of claim 17, further comprising outputting a further distinguishable optical, acoustic and/or haptic signal to the user by means of said output device (3, 4) in case said audio buffer (6) converted by said primary voice recognition process (8) and/or said text (13) analyzed by said dialog system (9) does not contain any relevant or any evaluable content.

19. The method of claim 1 wherein said primary voice recognition process (8) can distinguish different speakers by their voice by means of an acoustic model, and wherein said secondary voice recognition process (7) cannot distinguish different speakers,
whereby said secondary voice recognition process (7) triggers the execution of said primary voice recognition process (8) as soon as a keyword (18) or a phrase from any speaker is detected by said secondary voice recognition process (7), said primary voice recognition process (8) establishing from the speaker's voice whether he/she is entitled to utilize said software agent by means of said acoustic model and if there is no entitlement, said primary voice recognition process (8) is terminating or returning to the inactive state, and again passing on the control to said secondary voice recognition process (7).

20. The method of claim 1 wherein in case said dialog system (9) is not competent for a question, message or request in said audio recording (11), converted to text (13) by said primary voice recognition process (8), said dialog system (9) stores the context and/or the topic and/or the keywords (18) or phrases on a storage means so that the stored information is taken into consideration on one of the subsequent reactivations of said dialog system (9).
